(19) United States
(12) Patent Application Publication
(10) Pub. No.: US 2012/0221666 A1
(43) Pub. Date: Aug. 30, 2012

(54) SYSTEM AND METHOD FOR CONTROLLING ACCESS TO ELECTRONIC DEVICES

(75) Inventors: Philip Schentrup, Hollywood, FL (US); Vadim Kacherov, Boca Raton, FL (US); Larry G. Brown, Royal Palm Beach, FL (US)

(73) Assignee: OPENPEAK INC., Boca Raton, FL (US)

(21) Appl. No.: 13/033,726

(22) Filed: Feb. 24, 2011

(51) Int. Cl. G06F 15/16

(52) U.S. Cl. 709/208

(57) ABSTRACT

A system and method of controlling access to one or more electronic devices is disclosed. The method can include the step of—out of a plurality of electronic devices—identifying a master device and a slave device. The master device can be configured to control access to at least one feature of the slave device, and the master device can be associated with a person who has supervisory authority over another person who uses the slave device. During an active session on the slave device, a pre-disablement warning can be sent to the slave device in which the pre-disablement warning can identify a first time period by which access to the feature of the slave device is to be prevented. A disablement message can be sent to the slave device, thereby preventing access to the feature of the slave device following the expiration of the first time period.

### FIELD OF TECHNOLOGY

The subject matter herein is directed to controlling access to electronic devices and more particularly, to controlling access to electronic devices through a master device.

### BACKGROUND

The proliferation of electronic devices in today's society, particularly of the mobile variety, is impressive. Many families have multiple wireless devices that belong to one or more family members. Indeed, many parents have provided their children with cell phones, portable gaming units and other related devices. Supervising a child's time on such a device can be taxing, however. For example, a child involved with a gaming device may ignore several parental commands or deadlines, which can lead to frustration on a parent's part.

### SUMMARY

A method of controlling access to one or more electronic devices is described herein. Out of a plurality of electronic devices, a master device and a slave device can be identified. The master device can be configured to control access to at least one feature of the slave device, and the master device can be associated with a person who has supervisory authority over another person who uses the slave device. During an active session on the slave device, a pre-disablement warning can be sent to the slave device in which the pre-disablement warning identifies a first time period by which access to the feature of the slave device is to be prevented. A disablement message can be sent to the slave device, thereby preventing access to the feature of the slave device following the expiration of the first time period. As an example, the disablement message can be sent to the slave device following the expiration of the first time period.

As another part of the method, an enablement message can be sent to the slave device following the expiration of a second time period, thereby again allowing access to the feature of the slave device. In addition, the method can include the step of receiving a log-out indication from the slave device prior to the expiration of the first time period, thereby obviating the need to send the disablement message to the slave device.

In another arrangement, the pre-disablement warning can be sent to the slave device based upon a predetermined event or time. As an example, the predetermined event is a predefined amount of time that the slave device has been in use, an amount of power used by the slave device or entry by the slave device into a predefined location. In yet another arrangement, the pre-disablement warning can indicate that access to the feature of the slave device will be prevented and the length of the first time period. The master device and the slave device may communicate with one another in a peer-to-peer fashion or through a centrally-coordinated manner.

The method can also include the steps of identifying a supplemental device that assists in the functionality of the slave device and sending a separate disablement message to the supplemental device following the expiration of the first time period. This process can prevent the supplemental device from assisting the functionality of the slave device.

Another method of controlling access to a slave device from a master device is also described herein. The master device is associated with a person who has supervisory authority over another person who uses the slave device. During an active session on the slave device, a pre-disablement warning can be received at the slave device in which the pre-disablement warning identifies a first time period by which access to the feature of the slave device is to be prevented. In response to the receipt of the pre-disablement warning, at least the amount of time contained in the first time period can be displayed. A disablement message can be received at the slave device, and in response to the receipt of the disablement message, access to the feature of the slave device can be prevented following the expiration of the first time period. As an example, the disablement message can be received at the slave device following the expiration of the first time period.

The method can also include the steps of receiving an enablement message at the slave device following the expiration of a second time period and in response to the receipt of the enablement message, re-allowing access to the feature of the slave device. In one arrangement, a log-out command can be received at the slave device prior to the expiration of the first time period. In response to the log-out command, a log-out indication can be transmitted from the slave device to the master device. Displaying the amount of time contained in the first time period can include displaying a countdown of the amount of time contained in the first time period.

A system for controlling access to one or more electronic devices is also described herein. The system can include a master device and one or more slave devices. The master device can be configured to control access to at least one feature of the slave device, and the master device can be associated with a person who has supervisory authority over another person who uses the slave device. The master device can have a processor that can be operable to generate a pre-disablement warning for transmission to the slave device. The pre-disablement warning can include a first time period by which access to the feature of the slave device is to be prevented. In addition, the processor can be operable to generate a disablement message for transmission to the slave device in which the disablement message can cause access to the feature of the slave device to be blocked following expiration of the first time period.

The processor of the master device can be further operable to generate an enablement message for transmission to the slave device. This enablement message can re-establish access to the feature of the slave device following the expiration of a second time period. Moreover, the slave device can include a processor that can be operable to receive a log-out indication prior to the expiration of the first time period and to generate a notice for the master device to inform the master device of the log-out indication. The processor of the master device can be further operable to receive the notice of the log-out indication from the slave device, thereby obviating the need for the processor of the master device to generate the disablement message. In one arrangement, the processor of the master device can be further operable to generate the pre-disablement warning based upon a predetermined event or time. In yet another arrangement, the processor of the master device can be further operable to receive a command to convert the master device to a slave device. As another example, the pre-disablement warning and the disablement message can be part of a single message that the processor is operable to generate for transmission to the slave device. In yet another example, the pre-disablement warning, the disablement message and the enablement message can be part of a single message that the processor is operable to generate for transmission to the slave device.

A master device is also described herein. The master device can have a transceiver for transmitting or receiving communication signals and a processor coupled to the transceiver. The master device can be configured to control access to at least one feature of a corresponding slave device, and the master device is associated with a person who has supervisory authority over another person who uses the slave device. The processor can also be operable to generate a pre-disablement warning for display on the slave device during an active session of the slave device in which the pre-disablement warning identifies a first time period by which access to the feature of the slave device is to be prevented. The processor can also generate a disablement message for preventing access to the feature of the slave device in which access is prevented to the feature following the expiration of the first time period.

In one embodiment, the processor of the master device can be operable to receive a notice of a log-out indication from the slave device, which can obviate the need for the processor to generate the disablement message. In another embodiment, the processor can be further operable to generate the pre-disablement warning based upon a predetermined event or time. As an example, the predetermined event can be a predefined amount of time that the slave device has been in use, an amount of power used by the slave device or entry by the slave device into a predefined location. As another example, the pre-disablement warning and the disablement message can be part of a single message that the processor is operable to generate for transmission to the slave device.

Another method of controlling access to a slave device is described herein. In particular, during an active session on the slave device, a pre-disablement warning can be received at the slave device from a master device. The pre-disablement warning can identify a first time period by which access to the feature of the slave device is to be prevented. In response to the receipt of the pre-disablement warning, at least the amount of time contained in the first time period can be displayed. A disablement message can be generated at the slave device, and in response to the disablement message and following the expiration of the first time period, access to the feature of the slave device can be prevented.

In one embodiment, a log-out indication can be received prior to the expiration of the first time period, thereby obviating the need to generate the disablement message. Additionally, the process of counting down the first time period can be performed at the slave device.

Yet another method of controlling access to a slave device is described herein. Specifically, during an active session on the slave device, a pre-disablement warning can be generated at the slave device in which the pre-disablement warning identifies a first time period by which access to the feature of the slave device is to be prevented. In response to the pre-disablement warning, at least the amount of time contained in the first time period can be broadcast or displayed. A disablement message can be generated at the slave device, and in response to the disablement message and following the expiration of the first time period, access to the feature of the slave device can be prevented. In one arrangement, the pre-disablement warning can be generated in response to a predetermined event or time. As an example, the predetermined time or event can be established at a master device, and the slave device can receive the predetermined time or event from the master device.

A slave device is also described herein. The slave device can have a transceiver for transmitting or receiving communication signals and a processor coupled to the transceiver. The transceiver can receive a pre-disablement warning from a master device and can forward the pre-disablement warning to the processor in which the pre-disablement warning can identify a first time period by which access to a feature of the slave device is to be prevented. The processor can be operable to cause a user of the slave device to become aware of the pre-disablement warning. The processor can be further operable to generate a disablement message to prevent access to the feature of the slave device in which access can be prevented to the feature following the expiration of the first time period.

Yet another slave device is described herein. This slave device can have a transceiver for transmitting or receiving communication signals with a master device and a processor coupled to the transceiver. The transceiver can receive a pre-disablement warning from a master device and can forward the pre-disablement warning to the processor in which the pre-disablement warning can identify a first time period by which access to a feature of the slave device is to be prevented. The processor can be operable to cause a user of the slave device to become aware of the pre-disablement warning. Further, the processor can be operable to generate a disablement message to prevent access to the feature of the slave device in which access is prevented to the feature following the expiration of the first time period. In one arrangement, the pre-disablement warning can be generated in response to a predetermined event or time. As an example, the predetermined time or event can be established at the master device, and the slave device can receive the predetermined time or event from the master device.

Yet another method of controlling access to one or more electronic devices is described herein. In particular, a master device and a slave device can be identified out of a plurality of electronic devices in which the master device is configured to control access to at least one feature of the slave device. In addition, the master device can be associated with a person who has supervisory authority over another person who uses the slave device. As part of the method, a pre-disablement warning can be sent to the slave device in which the pre-disablement warning identifies a first time period by which access to the feature of the slave device is to be prevented. A disablement message can also be sent to the slave device, thereby preventing access to the feature of the slave device. The pre-disablement warning and the disablement message can be part of a single message. As an example, an enablement message can also be part of the single message. The enablement message can be configured to direct the slave device to again allow access to the feature of the slave device following the expiration of a second time period.

### BRIEF DESCRIPTION OF THE DRAWINGS

Embodiments of the present application will now be described, by way of example only, with reference to the attached Figures, wherein:

FIG. 1 illustrates an example of a system for controlling access to one or more electronic devices;

FIG. 2 illustrates examples of block diagrams of several electronic devices; and

FIG. 3 illustrates an example of a method of controlling access to one or more electronic devices.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

Several definitions that apply throughout this document will now be presented. A “master device” is defined as a device that at least controls some aspect of another device or causes the control of the aspect of that device, and a “slave device” is defined as a device in which at least some aspect of the device is under the control of a master device. The term “supervisory authority” is defined as a state in which one entity exerts control or power over another entity and encompasses familial and employment relationships. The term “single message” is defined as a message that is considered one unitary message or a message that is comprised of multiple messages or notifications that can be processed or transmitted as a unitary message. The term “peer-to-peer” is defined as a method or state of communications in which there is no central coordination or management of communications between a plurality of devices. Alternatively, the term “centrally-coordinated” is defined as a method or state of communications in which one or more units coordinate or manage communications between a plurality of devices. A “supplemental device” is defined as a device that assists some functional aspect of a slave device. A “transceiver” is defined as a component or a group of components that receives and/or transmits communication signals with one or more other entities, including through wireless or hard-wired configurations. The terms “send” or “sending” are defined as directing, transmitting or forwarding a signal from one destination to another or causing such directing, transmitting or forwarding to occur. Further definitions will be presented below.

As noted earlier, electronic devices have become ubiquitous in today's society, and it may be difficult to direct children who are engaged with such devices to other activities. For example, a parent may become frustrated when that parent's child is involved with a gaming device, and the parent has asked the child to finish the device's current session and join the rest of the family for some event, like dinner. To overcome this issue, several examples of systems and methods for controlling access to such devices are presented here.

In one particular example, a method can include the step of—out of a plurality of electronic devices—identifying a master device and a slave device. The master device can be configured to control access to at least one feature of the slave device, and the master device can be associated with a person who has supervisory authority over another person who uses the slave device. During an active session on the slave device, for example, a pre-disablement warning can be sent to the slave device in which the pre-disablement warning can identify a first time period by which access to the feature of the slave device is to be prevented. A disablement message can be sent to the slave device, thereby preventing access to the feature of the slave device following the expiration of the first time period.

Such a process can enable a user of a master device to selectively control access to a slave device by a user of the slave device, and a warning can be generated prior to preventing such access to help ensure compliance. This procedure can be especially useful when a parent wishes to extricate his/her child from, for example, a gaming unit or television. Moreover, in view of the warning provided to such a child, the child can no longer reasonably plead for additional time before the access is prevented.

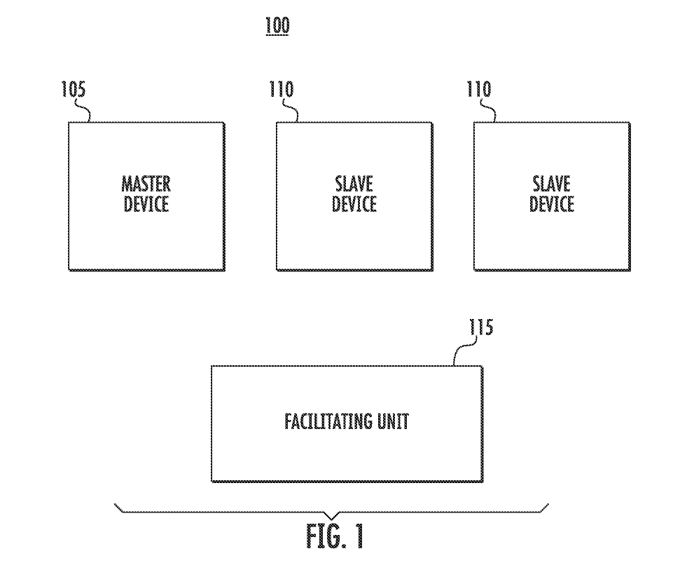

Referring to FIG. 1, an example of a system 100 for controlling access to one or more electronic devices is shown. In one arrangement, the system can include one or more master devices 105 and one or more slave devices 110. For simplification, this exemplary system 100 shows a single master device 105 and two slave devices 110, although such a configuration is not meant to be limiting, as any suitable number of master devices 105 and slave devices 110 can be used for purposes of controlling access. The master device 105 and the slave devices 110 can be configured to exchange signals in any suitable fashion. For example, a facilitating unit 115, such as a router, can be employed to assist in the exchange of signals between the master device 105 and the slave devices 110. In this example, the router can be part of a wireless local area network (WLAN) or a conventional (wired) local area network (LAN). Of course, the master device 105 and the slave devices 110 can be configured to directly communicate with one another without the assistance of any other devices. As such, the master device 105 and the slave devices 110 can communicate with one another in a peer-to-peer fashion.

In another arrangement, the master device 105 and the slave devices 110 can communicate through a centrally-coordinated manner. For example, the master device 105 and the slave devices 110 can be registered with a central coordination unit (not shown), and this unit can manage communications between the master device 105 and the slave devices 110 or direct the management of such communications. This type of management or coordination can be conducted over a WLAN, a LAN, a wide area network (WAN) or any other suitable network. In fact, these examples are not intended to limit the type or arrangement of communications between master and slave devices 105, 110, as those skilled in the art will appreciate that there are multiple ways for establishing such communications.

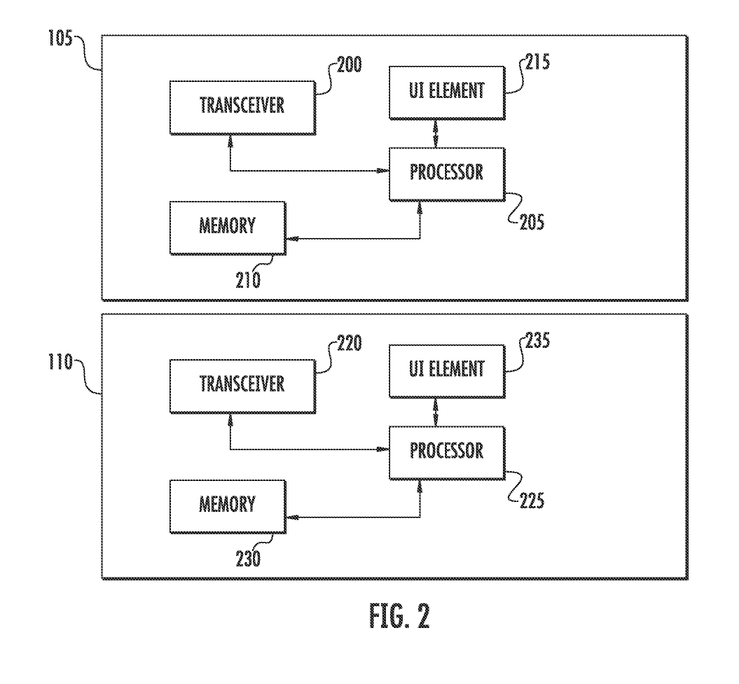

Referring to FIG. 2, examples of block diagrams for the master device 105 and one of the slave devices 110 are shown. Focusing on the master device 105, that device 105 can include a transceiver 200, a processor 205, memory 210 and a user interface (UI) element 215. The transceiver 200 can be configured to transmit and/or receive either wired or wireless signals (or both). In addition, the processor 205 may comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein. The memory 210 may be part of the processor 205 or may be a discrete component and can store any suitable type of information to facilitate operation of the master device 105. The UI element 215 can include any number and type of components that permit a user to engage or receive feedback from the master device 105, like a display, a touchscreen, a keypad, speakers, microphones, etc.

Similarly, the slave device 110 can include a transceiver 220, a processor 225, memory 230 and a UI element 235. The description presented above with respect to the components of the master device 105 can apply to the components shown here for the slave device 110. This feature does not necessarily mean that the master device 105 and the slave devices 110 are identical or even similar in construction or design, however, as they may contain different components and perform disparate functions.

The master device 105 and the slave devices 110 can be virtually any type of electronic device. As a specific but non-limiting example, the master device 105 and the slave devices 110 may be tablet-like components, each of which may be able to provide a gaming environment to a user. In this example, a parent may be assigned with the master device 105 and the children of the parent may be assigned with the slave devices 110. In another example, the master device 105 and the slave devices 110 may be equipped with software to enable an employee to perform a specified task. Here, a supervisor may be assigned with the master device 105, and one or more employees who report to the supervisor may be assigned to the slave devices 110. In either example, steps can be taken to assist the parent or the supervisor in the supervision of the children and the employees, respectively.

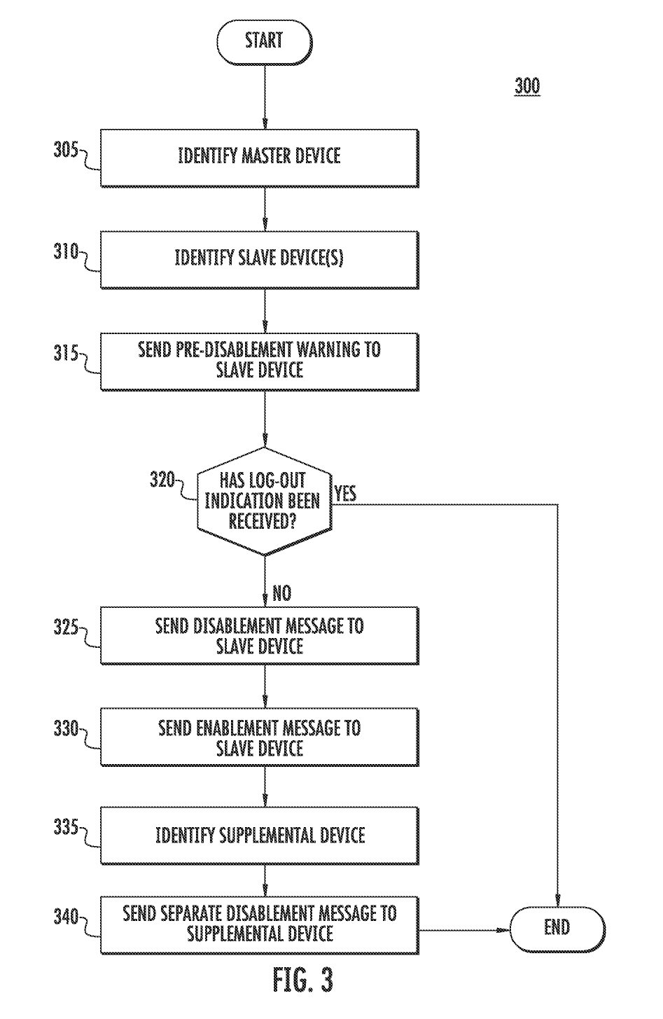

Referring to FIG. 3, an example of a method 300 for controlling access to one or more electronic devices is shown. When describing the method 300, reference will be made to the elements of FIGS. 1 and 2, although it is understood that the method 300 can be practiced in any other suitable system or with any other suitable components. Further, the method 300 is not necessarily limited to the chronological order presented in FIG. 3, as these steps can be executed in accordance with any suitable sequence. Also, the method 300 may be adjusted to include other processes or operations not recited here or to remove some of the steps illustrated in FIG. 3.

At step 305, a master device 105 can be identified out of a plurality of electronic devices, and at step 310, one or more slave devices 110 can be identified out of the plurality of electronic devices. In one arrangement, the master device 105 can be configured to control access to at least one feature of the slave device(s) 110. In another arrangement, the master device 105 can be associated with a person who has supervisory authority over another person who uses a slave device 110. For example, a parent and a manager may have supervisory authority over a child and an employee, respectively.

Considering the parent/child example, a parent may be in possession of several electronic devices. These devices may perform a variety of functions, some of which are geared towards the parent and some of which are tailored towards the child's tastes. The parent may designate or identify one of these devices as a master device and the others as slave devices. This initial designation can be performed at the identified master device, an identified slave device or some other suitable device in communication with one or more of the electronic devices. In addition, the designation of the master device and the slave device(s) can be communicated to one another over the connection that has been arranged between the devices, examples of which were previously described.

As noted above, the master device 105 can be configured to control access to at least one feature of the slave device(s) 110. The phrase “to control access to at least one feature” is defined as the capacity to remotely manipulate, manage, direct or restrict one or more functional abilities. For example, the master device 105 can be configured to cause any suitable application or process of a slave device 110 to shut down. As a more specific example, the master device 105 can be designed to cause a gaming or messaging application of the slave device 110 to shut down or otherwise become inoperable. As another example, the master device 105 can be operable to disable various user interface elements—like a display or keys on a keypad—or communication components—such as a transceiver—of the slave device 110 by causing them to power down or to become non-responsive. Of course, there are multiple ways in which a master device 105 can control access to a feature of a slave device 110, and the examples presented here are not meant to be limiting.

Referring back to the method 300, at step 315, during an active session on the slave device 110, a pre-disablement warning can be sent to the slave device 110. At decision block 320, it can be determined whether a log-out indication has been received. If a log-out indication has been received, the method 300 can terminate at the end step. If no log-out indication has been received, however, a disablement message can be sent to the slave device 110 at step 325, thereby preventing access to the feature of the slave device 110.

Consider the following exemplary scenario. A child may be engaged in an active session on the slave device 110. The term “active session” is defined as a process or operation that is currently being executed or carried out or at least on the verge of so. For example, the child may have initiated a gaming application and is currently using the application. The child's parent may wish to have the child participate in an event that requires the child to leave the active session. As an example, the parent may be close to finishing dinner preparations and desires to have the child cease playing the gaming application to join the family for the meal.

In one arrangement, the parent can direct the master device 105 to send a pre-disablement warning to the slave device 110 operated by the child. A “pre-disablement warning” is defined as a message that causes a warning to be established at a slave device to indicate that access to a particular feature is to be prevented in the future. As an example, the parent can manipulate the UI element 215, which can cause the processor 205 to generate the pre-disablement warning and to direct the transceiver 200 to send the warning to the relevant slave device 110 or some other relevant unit. As part of its composition, the pre-disablement warning can identify a first time period by which a feature of the slave device is to be prevented. The parent, in this example, may also provide instructions for the child to follow as part of the pre-disablement warning, such as a command to report to the kitchen for dinner. These instructions can be entered through the UI element 215.

Once transmitted, the transceiver 220 of the slave device 110 can receive and process the pre-disablement warning, in accordance with well-known techniques. In response, the processor 225 of the slave device 110 can cause the user of the slave device 110 to become aware of the pre-disablement warning, such as through the UI element 235. For example, the UI element 235 may include a display, and the processor 225 can cause the pre-disablement warning to be displayed. As part of this display, the pre-disablement warning can inform the user that access to a particular feature of the slave device 110 is to be prevented and that this prevention is to occur by the expiration of the first time period. The pre-disablement warning may also include any instructions for the child to follow, as provided by the parent. In the example cited above, the pre-disablement warning, any relevant instructions and the amount of time in the first time period can be displayed over any elements of the gaming application in use by the child to ensure that the child is aware of the warning. Although described in terms of a visual message, a user of the slave device 110 can be made aware of the pre-disablement warning in any other suitable fashion, such as through an audio message or through tactile feedback.

In another aspect, the user of the slave device 110 can continue to be apprised of the amount of time remaining in the first time period. For example, a countdown of the first time period can be displayed in a portion of the display that minimizes interference in the gaming application, yet that clearly indicates how much time is left before access to the relevant feature is to be prevented. Again, this countdown is not necessarily limited to visual means, as other techniques can be employed to indicate a countdown of the first time period, such as audible or tactile notices.

In one arrangement, the first time period can be any predefined time period, which can be determined by the user of the master device 105. In another arrangement, the first time period can begin to run upon the initial step executed to make the user of the slave device 110 cognizant of the pre-disablement warning. For example, if the user is to be made aware of the pre-disablement warning through visual means, the first time period can begin to run once the warning is displayed to the user. Of course, the first time period can be made to toll upon the occurrence of any other suitable event. In one embodiment, the slave device 110 can signal the master device 105 with an indication as to when the first time period started to run, which can enable the master device 105 to keep track of this countdown and determine its expected expiration.

The user of the slave device 110 may respond to the receipt of the pre-disablement warning by discontinuing the active session. For example, a child involved with the gaming application may terminate the session or shut down or deactivate some other relevant feature of the slave device 110 to render the gaming application inoperable or diminished in some significant way. In response, the processor 225 of the slave device 110 can generate a log-out indication and can signal the transceiver 220 of the slave device 110 to forward the indication to the master device 105 or some other suitable component. The term “log-out indication” is defined as a message that establishes or provides notice that an active session of a feature, application or other operational aspect of a slave device has been terminated, paused or otherwise put into a state in which its operational capacity is significantly diminished.

At this point, it may not be necessary for the master device 105 to generate a disablement message. In the example described above, the child has stopped playing the gaming application and presumably, will follow the provided instructions. If, however, the child ignores the pre-disablement warning, the processor 205 of the master device 105—following the expiration of the first time period—can generate a disablement message and can instruct the transceiver 200 to send the disablement message to the slave device 110. In one arrangement, the master device 105 can perform its own countdown of the first time period, or alternatively, the slave device 110 can signal the master device 105 when the first time period has expired. The term “disablement message” is defined as one or more commands or instructions that are intended to cause one or more components of a slave device to alter operation as part of an effort to prevent access to a feature of the slave device. Although this description illustrates the disablement message being both generated and transmitted following the expiration of the first time period, the disablement message can be generated and/or transmitted prior to this occurrence.

The transceiver 220 of the slave device 110 can receive the disablement message, process it in accordance with well known techniques and forward it to the processor 225. In response, the processor 225 can take action to prevent access to the relevant feature(s) of the slave device 110. In particular, the processor 225 can instruct the relevant UI element 235 or some other component to shut down or otherwise become inoperable. For example, the processor 225 of the slave device 110 can instruct a display of the slave device 110 to power down. In another example, the processor 110 can take steps to terminate the active gaming session or to perform a general shut down of the slave device 110. These examples are not intended to be limiting, as there are numerous steps that can be taken to prevent access to any suitable feature of the slave device 110.

The description above notes that the disablement message can be generated by the master device 105 and sent to the slave device 110. This feature is not meant to be limiting, however. In particular, the slave device 110 can be configured to simply take steps to prevent access to the appropriate feature when the first time period expires. This arrangement may obviate the need to generate the disablement message at the master device 105 and to transmit the message from the master device 105 to the slave device 110.

The example provided above in which a parent summons a child to dinner may be random in nature. That is, a parent may decide at any given time that the child should report to a particular location or should simply stop using the slave device 110. There may be instances where, however, the time at which a child should stop using the slave device 110 and/or report to a certain event may be known in advance. For example, the parent may consistently prepare and serve dinner at substantially the same time each day. As another example, the parent may wish to have the child begin preparations for bed at the same time each weeknight. In either case, the time involved is already known, and the parent can take steps to ensure that the child adheres to this regiment.

To do so, the parent can program the master device 105 to generate the pre-disablement warning and send it to the slave device 110 in anticipation of a predetermined time. The first time period can be a time period that can expire at the predetermined time. For example, the child may have a bedtime of 9:00 p.m. on weeknights. The master device 105 can be set to generate the pre-disablement warning a certain time period (i.e., the first time period) prior to 9:00p.m. If the slave device 110 has not responded with a log-out indication, then the master device 105 can generate and send to the slave device 110 the disablement message at the predetermined time, as described earlier. Of course, as noted before, the slave device 110 can perform the steps associated with the disablement message without having such a message generated and sent from the master device 110. Moreover, because the time involved here is a predetermined time, the slave device 110 can generate the pre-disablement warning itself, without the assistance of the master device 105.

In view of the above description, the pre-disablement warning can be sent to (or generated at) the slave device 110 based upon a predetermined time. The pre-disablement warning, however, may also be generated based on a predetermined event. Examples of predetermined events include a predefined amount of time that the slave device 110 has been in use, an amount of power that the slave device 110 has used or entry of the slave device 110 into a predefined location. Of course, there may be other events that can trigger a pre-disablement warning, as this listing is not meant to be exclusive. In any of these events, the slave device 110 can monitor relevant parameters, such as power level, time of use, location, etc., and can send updates to the master device 105, which can respond by generating pre-disablement warnings and disablements messages. In another arrangement, the slave device 110 can be programmed to generate the pre-disablement warning(s) and take any suitable action(s) to prevent access to the appropriate feature of the slave device 110, as the slave device 110 is cognizant of the relevant parameters and the triggering events. In addition, the master device 105 or the slave device 110 can also generate an enablement message to allow access to the appropriate feature of the slave device 110 once again.

Consider the following example. A parent may wish to limit a child's use of a gaming device to one hour per day. The parent can enter the restrictive information into the master device 105, which can signal the slave device 110. The child's use can then be monitored by one of or both of the master device 105 and the slave device 110. When the amount of time spent by the child using the slave device 110 comes within a first predetermined time period of the total allowed time for the day, the pre-disablement warning can be generated and displayed. Furthermore, if no log-out indication is received, steps can be taken to prevent access to some feature of the slave device 110 to cause the child to stop operating the slave device 110. An enablement message can also be processed by the slave device 110 to re-establish access to the disabled feature of the slave device 110 at a later time. Moreover, the timer that is used for purposes of monitoring the child's usage can be set at a predetermined time every day, week, etc., like every day at midnight.

As another example, the amount of power consumed by the slave device 110 or some other component can be monitored, and when the amount of consumed power reaches a predetermined level, the pre-disablement warning can be generated. If necessary, the slave device 110 can be configured to notify the master device 105 of the consumption of power reaching the predetermined level. Such a process can teach a user of the slave device 110 of the importance of conserving energy. As yet another example, the location of the slave device 110 can be monitored through any suitable means, and if the slave device 110 enters a predetermined area, a pre-disablement warning can be generated. Here, if necessary, the slave device 110 can periodically send location updates to the master device 105. Non-limiting examples of areas that would trigger the pre-disablement warning include school grounds or buildings, churches, libraries, intersections, etc.

For instance, a parent may not want his/her child to use the slave device 110 while at school and/or during school hours. In this case, the parent can enter into the master device 105 information that establishes the child's school or school hours as a restricted location or time, respectively, and the master device 105 can signal the slave device 110 with these settings. The slave device 110, once it determines that it is within the restricted location (i.e., school grounds) or detects the restricted time period (i.e., school hours), can take action to prevent access to the appropriate feature of the slave device 110. For example, the child could be blocked from making calls, receiving/sending text messages, connecting to communication networks or accessing all or certain applications while at school and/or during school hours. Provisions can be made to ensure that the child (or other user) can place emergency calls as needed.

As noted above, the slave device 110 can generate a pre-disablement warning on its own, which can be based on a predetermined time or event. In one example, the operator of the master device 105 can determine or establish such predetermined times or events at the master device 105. The master device 105 can then make the slave device 110 aware of these predetermined times or events by communicating such information to the slave device 110. Once it is aware of these parameters, the slave device 110 can monitor them on its own. For example, an operator of the master device 105 can input information into the master device 105 to indicate that a bedtime for a particular child-user of the slave device is 9:00 p.m. The master device 105 can then send this information to the slave device 110, which can then monitor an internal clock for the purpose of generating pre-disablement warnings in anticipation of the 9:00 p.m. time.

Referring back to the method 300, at step 330, following the expiration of a second time period, an enablement message can be sent to the slave device 110, which can again allow access to the feature of the slave device 110. For example, if the slave device 110 receives the disablement message and the feature of the slave device 110 is disabled, the master device 105 can generate and send an enablement message to the slave device 110 after a second predetermined time period. When the slave device 110 receives the enablement message, the slave device 110 can perform steps necessary to allow the user of the slave device 110 to again have access to the previously disabled feature. The user of the master device 105 can set this second predetermined time period, although it is understood that the slave device 110 can monitor the time of the second predetermined time period and generate the enablement message itself.

In one arrangement, this second predetermined time period can be adjusted based on the behavior of the user of the slave device 110. For example, if a child continuously has the feature of the slave device 110 disabled, the parent can increase the length of time of the second predetermined time period. This process will increase the amount of time before the child can use the slave device 110 again and can serve as a deterrent to the child continuously ignoring the pre-disablement warning.

It should be noted that there are other ways in which the master device 105 and the slave device(s) 110 may exchange messages. For example, instead of sending the pre-disablement warning and the disablement message as separate messages, these exchanges can form part of one notification, or a single message. In particular, when the master device 105 determines that access to a slave device 110 is to be controlled or adjusted, the master device 105 can generate and transmit to the slave device 110 a single message that includes both the pre-disablement warning and the disablement message. Once received, the slave device 110 can process the pre-disablement warning and the disablement message and perform relevant actions, as described above (i.e., notify the user of the pre-disablement warning and disable access to the feature if necessary). As part of this description, the enablement message, if such a feature is to be utilized, may also be (optionally) part of the message that includes both the pre-disablement warning and the disablement message. This process can minimize the number of messages that are exchanged between the master device 105 and the slave device(s) 110.

Referring once again to the method 300, at step 335, a supplemental device that assists in the functionality of the slave device can be identified. At step 340, a separate disablement message can be sent to the supplemental device following the expiration of the first time period. Specifically, the slave device 110 may operate in conjunction with a supplemental device to enhance or even make possible the operation of the slave device 110. For example, the supplemental device can be a television or a computer monitor that can be communicatively linked to the slave device 110 and that can display images based on the operation of the slave device 110. As another example, the slave device 110 can be a light, a speaker or joystick or some other comparable structure. These examples are not meant to be limiting, however. The term “supplemental device” is defined as a device that enhances, assists or otherwise makes possible the operation of a slave device.

One or more supplemental devices can be configured to be communicatively linked to the master device 105 through any suitable means. In one arrangement, the operator of the master device 105 can register one or more supplemental devices with the master device 105, which can permit the master device 105 to control the operation of such devices. Thus, as an option, the user of the master device 105 can cause the master device 105 to send a disablement message to the supplemental device following the expiration of the first time period. This disablement message, when received by the supplemental device, can cause the supplemental device to shut down or alter in some fashion its operation, which can lead the operator of the slave device 110 to respond in a desired manner. For example, a parent who is attempting to summon a historically recalcitrant child to dinner may remotely shut down the slave device 110 and the lights (i.e., supplemental device) in the child's room in an effort to have the child responds to the parent's wishes about dinner.

In accordance with the description above, the master device 105 can be configured to operate with any suitable number of slave devices 110. In one arrangement, a master device 105 may be converted into a slave device 110, and a slave device 110 may be converted into a master device 105. For example, a parent may acquire a new electronic device and can identify the new device as a master device 105. The parent may then convert the old master device 105 into a slave device 110, such as by entering suitable commands through a user interface of the old master device 105 or some other appropriate component. If this new slave device 110 is registered with the new master device 105, then the new master device 105 can control access to the new slave device 110 in accordance with the examples described above. As another example, the current master device 105 may malfunction. If desired, the parent can simply convert one of the slave devices 110 into a new master device 105 to control access to the remaining slave devices 110.

The flowcharts and block diagrams in the figures illustrate the architecture, functionality, and operation of possible implementations of systems, methods and computer program products according to various embodiments. In this regard, each block in the flowchart or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suitable. A typical combination of hardware and software can be a processing system with computer-usable or computer-readable program code that, when being loaded and executed, controls the processing system such that it carries out the methods described herein. The systems, components and/or processes also can be embedded in a computer-readable storage medium, such as a computer-readable storage medium of a computer program product or other data programs storage device, readable by a machine, tangibly embodying a program of instructions executable by the machine to perform methods and processes described herein. These elements also can be embedded in an application product that comprises all the features enabling the implementation of the methods described herein and, when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; and b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

Other definitions that apply throughout this document will also be presented here. The terms “a” and “an” are defined as one or more than one. The term “plurality” is defined as two or more than two. The term “another” is defined as at least a second or more. The terms “including” and/or “having” are defined as comprising (i.e. open language). The term “coupled” is defined as connected and includes direct or indirect physical contact between two or more elements or wireless contact between two or more elements.

Moreover, as used herein, ordinal terms (e.g., first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

Examples have been described above regarding a system and method for controlling access to one or more electronic devices. Various modifications to and departures from the disclosed embodiments will occur to those having skill in the art. The subject matter that is intended to be within the spirit of this disclosure is set forth in the following claims.

What is claimed is:

1. A method of controlling access to one or more electronic devices, comprising:
out of a plurality of electronic devices, identifying a master device;
out of the plurality of electronic devices, identifying a slave device, wherein the master device is configured to control access to at least one feature of the slave device and wherein the master device is associated with a person who has supervisory authority over another person who uses the slave device;
sending a pre-disablement warning to the slave device, wherein the pre-disablement warning identifies a first time period by which access to the feature of the slave device is to be prevented; and
sending a disablement message to the slave device, thereby preventing access to the feature of the slave device.

2. The method according to claim 1, wherein the disablement message is sent to the slave device following the expiration of the first time period.

3. The method according to claim 1, further comprising sending an enablement message to the slave device following the expiration of a second time period, thereby again allowing access to the feature of the slave device.

4. The method according to claim 2, further comprising receiving a log-out indication from the slave device prior to the expiration of the first time period, thereby obviating the need to send the disablement message to the slave device.

5. The method according to claim 1, further comprising sending the pre-disablement warning to the slave device based upon a predetermined event or time.

6. The method according to claim 5, wherein the predetermined event is at least one of a predefined amount of time that the slave device has been in use, an amount of power used by the slave device or entry by the slave device into a predefined location.

7. The method according to claim 1, wherein the pre-disablement warning indicates that access to the feature of the slave device will be prevented and the length of the first time period.

8. The method according to claim 1, wherein the master device and the slave device communicate with one another in a peer-to-peer fashion or through a centrally-coordinated manner.

9. The method according to claim 2, further comprising:
identifying a supplemental device that assists in the functionality of the slave device; and
sending a separate disablement message to the supplemental device following the expiration of the first time period, thereby preventing the supplemental device from assisting the functionality of the slave device.

10. A method of controlling access to a slave device from a master device in which the master device is associated with a person who has supervisory authority over another person who uses the slave device, comprising:
during an active session on the slave device, receiving a pre-disablement warning at the slave device, wherein the pre-disablement warning identifies a first time period by which access to the feature of the slave device is to be prevented;
in response to the receipt of the pre-disablement warning, displaying at least the amount of time contained in the first time period; and
receiving a disablement message at the slave device; and
in response to the receipt of the disablement message, preventing access to the feature of the slave device following the expiration of the first time period.

11. The method according to claim 10, wherein the disablement message is received at the slave device following the expiration of the first time period.

12. The method according to claim 10, further comprising:
receiving an enablement message at the slave device following the expiration of a second time period; and
in response to the receipt of the enablement message, re-allowing access to the feature of the slave device.

13. The method according to claim 11, further comprising:
receiving a log-out command at the slave device prior to the expiration of the first time period;
in response to the log-out command, transmitting a log-out indication from the slave device to the master device.

14. The method according to claim 10, wherein displaying the amount of time contained in the first time period further comprises displaying a countdown of the amount of time contained in the first time period.

15. A system for controlling access to one or more electronic devices, comprising:
a master device;
one or more slave devices, wherein the master device is configured to control access to at least one feature of the slave device and wherein the master device is associated with a person who has supervisory authority over another person who uses the slave device;
wherein the master device comprises:
a processor, wherein the processor is operable to generate a pre-disablement warning for transmission to the slave device, wherein the pre-disablement warning includes a first time period by which access to the feature of the slave device is to be prevented
wherein the processor is further operable to generate a disablement message for transmission to the slave device, wherein the disablement message causes access to the feature of the slave device to be blocked following expiration of the first time period.

16. The system according to claim 15, wherein the processor of the master device is further operable to generate an enablement message for transmission to the slave device, wherein the enablement message re-establishes access to the feature of the slave device following the expiration of a second time period.

17. The system according to claim 15, wherein the slave device includes a processor that is operable to receive a log-out indication prior to the expiration of the first time period and to generate a notice for the master device to inform the master device of the log-out indication.

18. The system according to claim 17, wherein the processor of the master device is further operable to receive the notice of the log-out indication from the slave device, thereby obviating the need for the processor of the master device to generate the disablement message.

19. The system according to claim 15, wherein the processor of the master device is further operable to generate the pre-disablement warning based upon a predetermined event or time.

20. The system according to claim 15, wherein the processor of the master device is further operable to receive a command to convert the master device to a slave device.

21. The system according to claim 15, wherein the pre-disablement warning and the disablement message are part of a single message that the processor is operable to generate for transmission to the slave device.

22. The system according to claim 16, wherein the pre-disablement warning, the disablement message and an enablement message are part of a single message that the processor is operable to generate for transmission to the slave device.

23. A master device, comprising:
a transceiver for transmitting or receiving communication signals; and
a processor coupled to the transceiver, wherein the master device is configured to control access to at least one feature of a corresponding slave device and wherein the master device is associated with a person who has supervisory authority over another person who uses the slave device;
wherein the processor is operable to generate a pre-disablement warning for display on the slave device during an active session of the slave device, wherein the pre-disablement warning identifies a first time period by which access to the feature of the slave device is to be prevented;
wherein the processor is further operable to generate a disablement message for preventing access to the feature of the slave device, wherein access is prevented to the feature following the expiration of the first time period.

24. The master device according to claim 23, wherein the processor is further operable to receive a notice of a log-out indication from the slave device, thereby obviating the need for the processor to generate the disablement message.

25. The master device according to claim 23, wherein the processor is further operable to generate the pre-disablement warning based upon a predetermined event or time.

26. The master device according to claim 25, wherein the predetermined event is a predefined amount of time that the slave device has been in use, an amount of power used by the slave device or entry by the slave device into a predefined location.

27. The master device according to claim 23, wherein the pre-disablement warning and the disablement message are part of a single message that the processor is operable to generate for transmission to the slave device.

28. A method of controlling access to a slave device, comprising:
receiving from a master device a pre-disablement warning at the slave device, wherein the pre-disablement warning identifies a first time period by which access to the feature of the slave device is to be prevented;
in response to the receipt of the pre-disablement warning, displaying at least the amount of time contained in the first time period; and
generating a disablement message at the slave device; and
in response to the disablement message and following the expiration of the first time period, preventing access to the feature of the slave device.

29. The method according to claim 28, further comprising receiving a log-out indication prior to the expiration of the first time period, thereby obviating the need to generate the disablement message.

30. The method according to claim 28, further comprising counting down the first time period at the slave device.

31. A method of controlling access to a slave device, comprising:
during an active session on the slave device, generating a pre-disablement warning at the slave device, wherein the pre-disablement warning identifies a first time period by which access to the feature of the slave device is to be prevented;
in response to the pre-disablement warning, displaying or broadcasting at least the amount of time contained in the first time period; and
generating a disablement message at the slave device; and
in response to the disablement message and following the expiration of the first time period, preventing access to the feature of the slave device.

32. The method according to claim 31, wherein the pre-disablement warning is generated in response to a predetermined event or time.

33. The method according to claim 31, wherein the predetermined time or event is established at a master device and the slave device receives the predetermined time or event from the master device.

34. A slave device, comprising:
a transceiver for transmitting or receiving communication signals; and
a processor coupled to the transceiver;
wherein the transceiver is configured to receive a pre-disablement warning from a master device and to forward the pre-disablement warning to the processor, wherein the pre-disablement warning identifies a first time period by which access to a feature of the slave device is to be prevented;
wherein the processor is operable to cause a user of the slave device to become aware of the pre-disablement warning;
wherein the processor is further operable to generate a disablement message to prevent access to the feature of the slave device, wherein access is prevented to the feature following the expiration of the first time period.

35. A slave device, comprising:
a transceiver for transmitting or receiving communication signals with a master device; and
a processor coupled to the transceiver;
wherein the transceiver is configured to receive a pre-disablement warning from a master device and to forward the pre-disablement warning to the processor, wherein the pre-disablement warning identifies a first time period by which access to a feature of the slave device is to be prevented;
wherein the processor is operable to cause a user of the slave device to become aware of the pre-disablement warning;
wherein the processor is further operable to generate a disablement message to prevent access to the feature of the slave device, wherein access is prevented to the feature following the expiration of the first time period.

36. The slave device according to claim 35, wherein the pre-disablement warning is generated in response to a predetermined event or time and the predetermined time or event is established at the master device and the slave device receives the predetermined time or event from the master device.

37. A method of controlling access to one or more electronic devices, comprising:
out of a plurality of electronic devices, identifying a master device;
out of the plurality of electronic devices, identifying a slave device, wherein the master device is configured to control access to at least one feature of the slave device and wherein the master device is associated with a person who has supervisory authority over another person who uses the slave device;
sending a pre-disablement warning to the slave device, wherein the pre-disablement warning identifies a first time period by which access to the feature of the slave device is to be prevented; and
sending a disablement message to the slave device, thereby preventing access to the feature of the slave device, wherein the pre-disablement warning and the disablement message are part of a single message.

38. The method according to claim 37, wherein an enablement message is also part of the single message and the enablement message is configured to direct the slave device to again allow access to the feature of the slave device following the expiration of a second time period.
